(19) United States
(12) Patent Application Publication
(10) Pub. No.: US 2006/0240894 A1
(43) Pub. Date: Oct. 26, 2006

(54) Online gaming method integrating information, prizes, and advertising from live events and from specific event centers

(76) Inventor: Paul D. Andrews, Arvada, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 11/112,949

(22) Filed: Apr. 22, 2005

(51) Int. Cl. G06F 19/00; G06F 17/00

(52) U.S. Cl. 463/42

(57) ABSTRACT

A computer-based method for serving an online game linked to concurrent operation of an event center. The online game is designed to generate game elements or characters configured based on characteristics or features of the event center. A schedule is determined for playing the online game, and the scheduled time period includes occurrence of events at the event center. The method includes serving the online game to client devices over a network during the playing schedule. The method includes awarding prizes to the operators associated with high scores, and prizes include event center-linked prizes. The game elements are defined based on structural features of the event center and characteristics of event performers. Game elements include advertising banners presenting advertising data associated with the event center or events at the event center and/or include a display area for displaying data collected from event center during the occurrence of the event.

### BACKGROUND OF THE INVENTION

1. Field of the Invention

The present invention relates, in general, to computer and network methods and techniques for providing online, skill-based games and providing online advertising, and, more particularly, to a computer-based method and computer systems for providing an online game in a manner that ties or integrates the game with live sporting or other entertainment events and ties the game to a particular event center. The method and system are configured to link concurrent events and information from data collection devices and data structures at the event center with an ongoing (i.e., being served) online game.

2. Relevant Background

With the rapid expansion of digital communications networks, such as the Internet, online gaming has become increasing popular. Online gaming typically involves a player using a network device, e.g., nearly any computing or communication device capable of connecting with a network, to connect to a game server, to select a game to play, to download the game, and to play the game. The network or client device may take many forms such as a personal computer, a laptop, handheld, or notebook computer, a wireless device, a cellular or wireless telephone, or the like but will typically be running software applications that allow it to communicate with the gaming server, allow it to provide game input such as with a mouse, a keyboard, a touch screen, or the like, and allow it to display the ongoing game. For example, the network device may include a browser that allows the player to interact with the game being run on the network device. In contrast to video games played on specially-developed gaming systems, online games are developed and designed to require only minimal processing capacity, memory, and graphical performance. As a result, nearly anyone with a network device can access and play online games from fixed locations, such as their homes, or while on the move.

Online games take a wide variety of forms and are generally designed to have very few rules or low complexity while still being fun to play and sometime humorous. Often, the online games are games of skill in which a player takes action, such as by hitting the space bar or other input keys, at a particular time to score points by causing game characters or game elements to behave in a particular fashion. For example, a player playing an online soccer game may hit keys or otherwise provide input to score as many goals as possible in a fixed amount of time. In arcade type games, a player may provide input to aim and fire a weapon. The subject matter of games has been widely varied to attract game players or contestants and includes all types of sports-related games, action-based games, and other games of skill such as card games, e.g., poker and the like.

Online games are typically developed and presented on networks, such as the Internet, to generate profits for the operator of the web site presenting the game. The profits may be generated in the form of direct charges for playing the online game, but more typically, the profits are generated from advertising revenue. The operator of the web site through which the online games are served will charge for advertising space on the web site and will be able to charge higher rates for this space with increased traffic, i.e., when numerous players access the web site to play the game. Some work has even been done to provide advertising within an online game, such as by running banner advertisements in an online game for certain advertisers (see, for example, U.S. Pat. No. 6,196,920).

Presently, there are a large number of online games available over the Internet and other networks. As a result, there is a push within the online gaming industry to find new and creative techniques for effectively attracting players to their web site and to play their offered games. One method involves creating a web site that appears high on a search engine results list, but this only effective in initially attracting players and has little lasting value if the games are not attractive to the players. Another method is to provide new games on an ongoing basis to obtain repeat visitors. While providing improving the effectiveness of an online game web site, this method requires continuing expenditure on new and better online games that may or not attract additional players. An increasing popular method of attracting players to a web site is to provide prizes, e.g., cash prizes, to winners or players with higher scores. This is typically done by charging for playing the online game and then, returning all or a percentage of the paid game fees to the players or contestants in the form of cash prizes. Awarding only cash prizes, however, is often only effective in drawing a limited set of serious players who repeatedly play the game while actually reducing the number of new players who visit the site, which is the goal of the web site operator.

Hence, there remains a need for an improved method and system for providing an online game over a communications network. Such a method and system would preferably be effective in attracting a large number of players or contestants to play an online game and also, in attracting a large percentage of repeat players. Further, it is preferable that the method and system are configured to more effectively present advertising information to the players.

### SUMMARY OF THE INVENTION

The present invention addresses the above and other problems by providing an online gaming method and system that uniquely links the provision of an online game with operations of an event center, such as a stadium that hosts sporting events. Typically, the online game is offered over a network such as the Internet as a pay-per-play game that players can access with nearly any client device linked to the network. The online game is configured to be linked or tied to the event center and events occurring at the event center in a number of ways. The online game typically is configured to generate a number of game elements, such as structural features of the game or characters in the game, and a number of information displays or banners. The game elements are preferably defined by game element parameter values that are defined based on the event center and/or its events, e.g., such that the game has as its environment a portion of the event center, the theme of the game is similar to events at the event center, and/or characters in the game are participants in the events held at the center. The information displays or banners are used by the online game to present advertising data provided by the event center (e.g., advertising content concurrently being displayed at the event center on its display mechanisms) and/or to present data collected at the event center such as a game score or the like for an event taking place concurrently with game play.

The online game is further linked to the event center and its events by the generation of a pool of prizes that are linked to the event center (such as tickets to then next event) and/or to the event or its participants (such as signed jerseys, passes to meet the participants, or the like). The schedule for playing the game also links the game to the event center with the schedule typically being determined to at least partially overlap with one or more events or games being held at the event center. At the end of the game playing schedule, winners are determined and the winners announced at the event center with awards often being presented during a later held event at the event center.

More particularly, a computer-based method is provided for serving an online game, which is linked to an event center and data stored and gathered at the event center. The method includes providing on a server an online game that includes or generates a number of game elements, with some of the game elements being configured based on characteristics or features of the event center. A schedule is determined for playing the online game that defines a time period in which scores will be tracked and gathered, and the time period includes an occurrence of at least one event at the event center. The method continues with serving the online game to a plurality of client devices over a communications network for a length of time equal to the playing schedule. During such serving of the game, the method includes gathering scored for the online game for operators of the client devices and then, determining a set of high scores for the online game from the gathered scores. The method typically also includes awarding a set of prizes to the operators associated with the high scores, and significantly, the prizes include event center-linked prizes, such as prizes related to the performers in the event held at the event center. The end of the game playing time period may coincide with the ending time of the event (or the last event in a series of such events) held at the event center. The game elements may be configured or defined based on parameter values defined based on structural features of the event center and/or based on characteristics of event performers or other event features (such as team mascots or the like). The game elements may also be configured to include an advertising banner for presenting advertising data, which may be associated with the event center or events at the event center and/or may be configured to include a display area for displaying data collected from event center during the occurrence of the event.

### BRIEF DESCRIPTION OF THE DRAWINGS

FIG. 1 illustrates in block form an online gaming system according to the present invention;

FIG. 2 illustrates a simplified, exemplary screen shot as may be seen on a player client device during operation of the online gaming system of FIG. 1 showing the inclusion of event center-specific information;

FIG. 3 illustrates another embodiment of a game screen shot similar to the one shown in FIG. 2 but further including event center-linked advertising and also, event data from the event center;

FIG. 4 illustrates an exemplary display mechanism, such as may be provided in the system of FIG. 1, operating to display game information including a current leader board and game advertiser or sponsor information;

FIG. 5 illustrates a screen shot of a television broadcast from a media system showing the display of online game information, such as in the bottom banner or scrolling ticker;

FIG. 6 is a flow chart of a method of providing an online game according to the present invention as may be completed during operation of the system of FIG. 1; and

FIG. 7 is a flow chart of a method of administering an online game as may be performed during operation of the system of FIG. 1.

### DETAILED DESCRIPTION OF THE PREFERRED EMBODIMENTS

Generally, the invention is directed to a method and system for integrating an online video game, with a particular event center and activities occurring at the event center. In this regard, the method and system are configured to address the challenges and problems associated with collecting data and information at an event center and presenting portions of this data to a player of the online game. The event center data may include advertising information and/or activity related information (e.g., the score of a game, the teams playing the game, and the like) and may also include information that affects the games environmental features (such as characteristics of the event center) and game characters or elements. Prizes are utilized to entice players to play the online game, and in one embodiment, the prizes are linked or tied to the event center and its activities.

Another challenge addressed by the method and system of the invention is interfacing information collected while players play the game, including determining a set of high scores or a leader board used to determine which players are awarded event center-linked prizes. The leader board is preferably determined on an ongoing basis with the leader board being accessible in real time by the players over the network and with the leader board being displayed at the event center and over other marketing channels, e.g., via television or other media. In addition to the leader board, administration of the online game may include providing game related information at the corresponding event center on one or more of its display devices, which requires interfacing the online game server with an online game administrator at or in communication with operating systems of the event center.

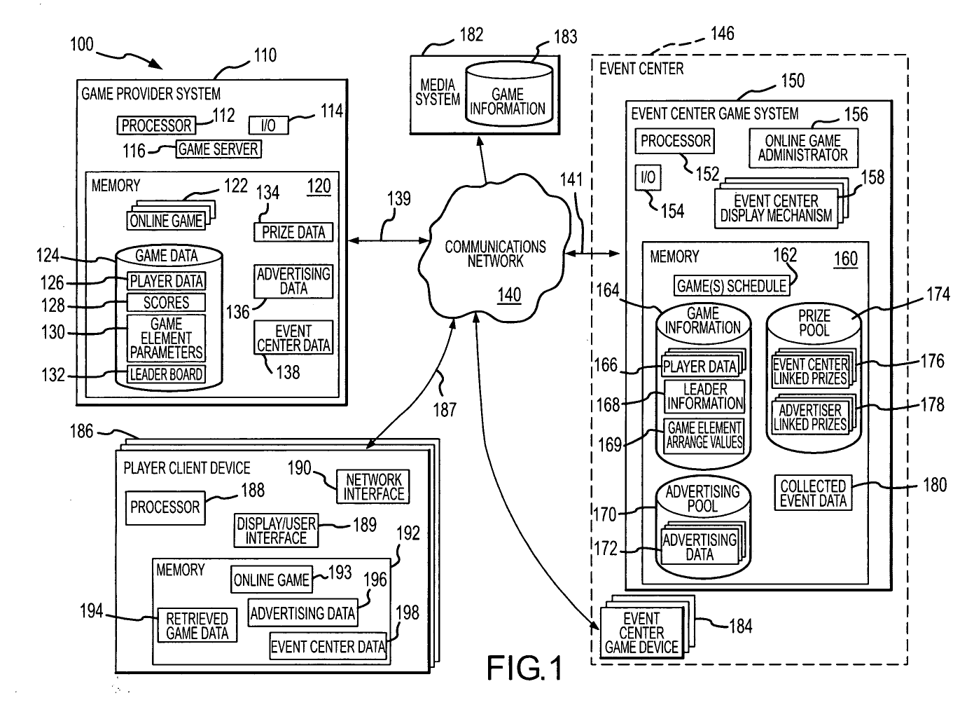

In the following discussion, computer and network devices, such as the software and hardware devices within the online gaming system 100 are described in relation to their function rather than as being limited to particular electronic devices and computer architectures and programming languages. To practice the invention, the computer, client, network, and storage devices may be any devices useful for providing the described functions, including well-known data processing and communication devices and systems, such as application, database, web, and entry level servers, midframe, midrange, and high-end servers, personal computers and computing devices (such as player client devices 184, 186 of FIG. 1) including mobile computing and electronic devices with processing, memory, and input/output components and running code or programs in any useful programming language, and server devices configured to maintain and then transmit digital data over a wired or wireless communications network. Data storage systems and components, such as memory, are described herein generally and are intended to refer to nearly any device and media useful for storing digital data such as tape-based devices and disk-based devices, their controllers or control systems, and any associated software. Data, including transmissions to and from the elements of the system 100, typically is communicated in digital format following standard communication and transfer protocols, such as TCP/IP, FC, FC-AL, SCSI, PCI, HTTP, HTTPS, FTP, and the like, or IP or non-IP wireless communication protocols.

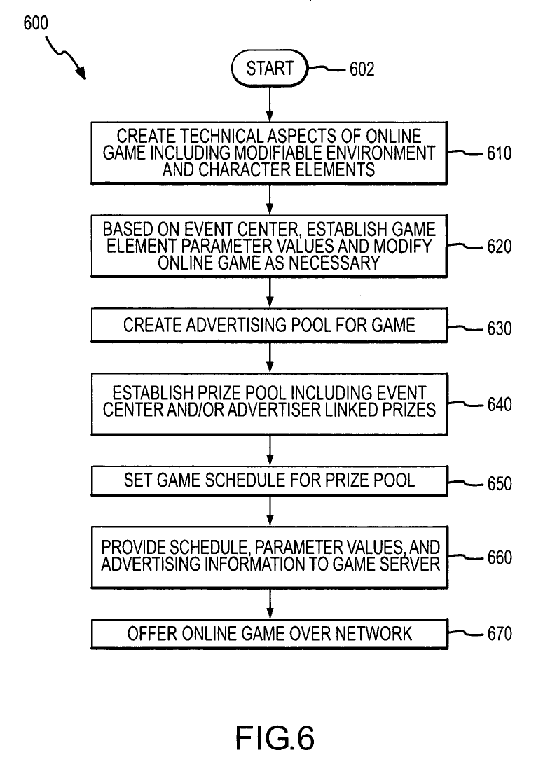

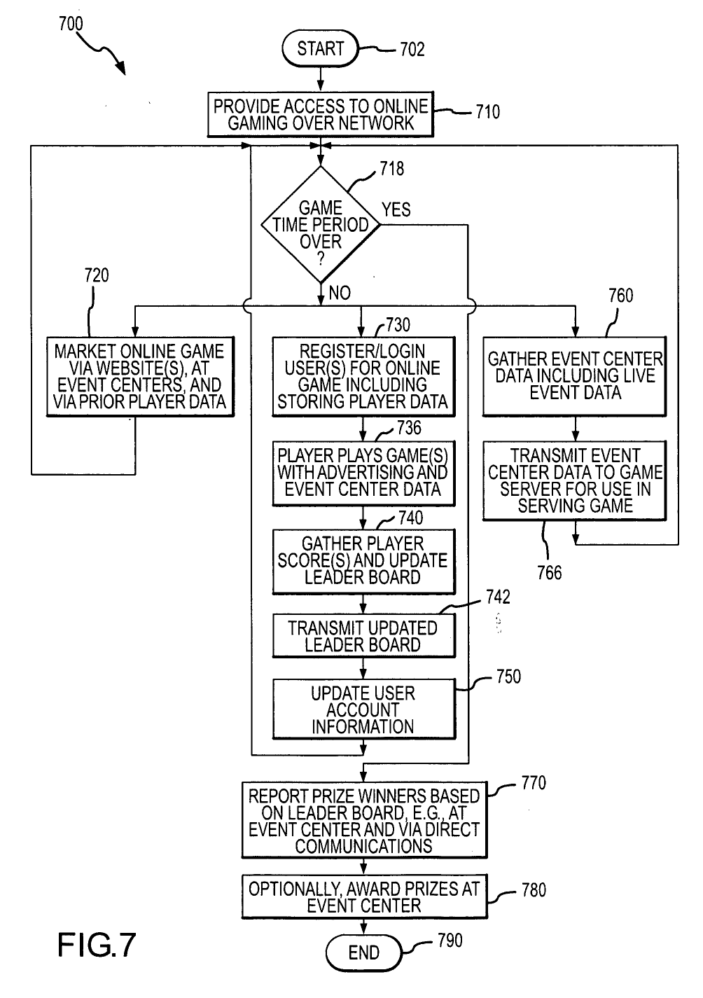

FIG. 1 illustrates an online gaming system 100 of the present invention that is configured or adapted to operate to the online game provision process 600 and online game administrate process 700 of FIGS. 6 and 7, respectively. As shown, the system 100 includes a game provider system 110 that operates to serve online games 122 to player client devices 184 and 186 over a digital communications network 140, e.g., the Internet, a LAN, a WAN, or other network(s), via wired and/or wireless links 139, 188. The system 100 also includes an event center game system 150 linked to the game provider system 110 via links 139, 141 and network 140. The event center game system 150 is located in the illustrated embodiment at an event center 146, such as a stadium constructed and operated to host sporting events such as basketball, hockey, football, baseball, and the like or entertainment events such as concerts, theatrical plays, and the like. The following description emphasizes the use of the system 100 to integrate play of an online game with an event center 146 used to host sporting events, such as basketball games, but this is not intended as a limitation of the invention as the invention is readily applicable to nearly any event or activity held at an event center (which in this description is intended to mean any building or enclosure open to the environment or not in which an event takes place and typically in which fans or individuals enter to watch the event or activity, such as, but not limited to, a sports stadium or arena). The provision of the event center game system 150 at the event center 146 facilitates (as will become clear) integration of the online games 122 with the event center 146. Additionally, the system 100 includes one or more media systems 182, such as television station computing systems, which function to receive and display or output game information 183 received from the event center game system 140 and/or the game provider system 110.

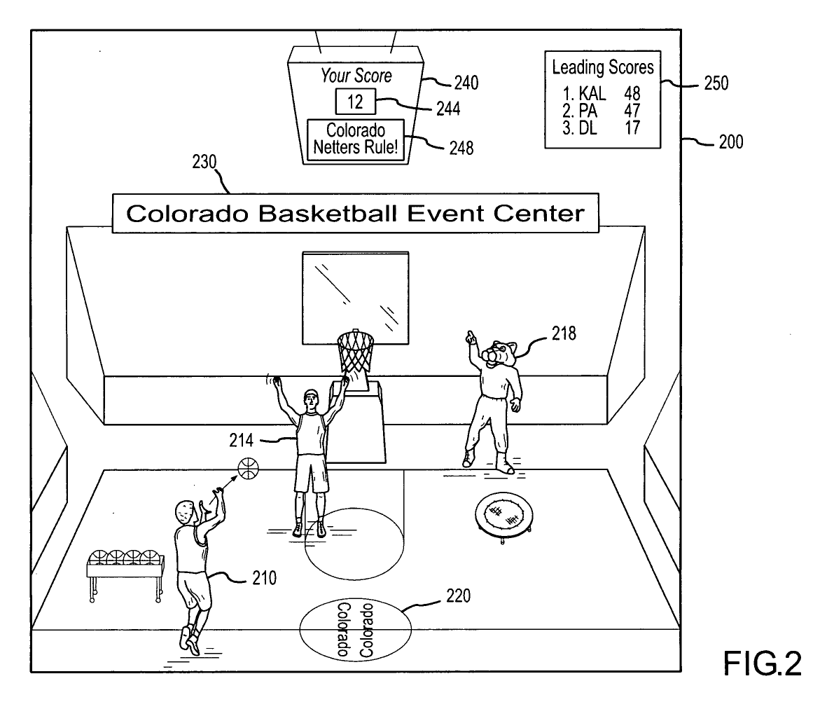

The game provider system 110 is generally a computer system, such as a server with data storage capabilities or access to such devices, that functions to host one or more online games 122. As shown, the game provider system 110 includes a processor or CPU 112 for managing memory 120 and I/O devices 114 and running software applications or programs including game server 116. I/O devices 114 are provided for interfacing with the network 140 and allowing an operator of the system 110 to input data and view information. The game server 116 is run to provide the functionality described with reference to FIGS. 2-7 including processing data from client devices 184, 186, registering players, monitoring player account data, processing data/information from the event center game system 150, and transmitting game and player data selectively to the event center game system 150.

The game provider system 110 includes memory 120 that functions to store online games 122 that can be accessed, such as via a web site hosted by the game provider system 110, and downloaded for play by client devices 184, 186. As will become clear, the online games 122 are developed and run to be linked to the event center 146 and at least in some embodiments, to ongoing activities at the event center 146. In this regard, a database 124 of game data is stored in the memory 120 including player data 126, such as a player identification, contact and demographic information, and account information, game scores 128 for each online game 122, game element parameter values 130, and a leader board or set of players with high scores 132 including the high score and player identification information. The game element parameter values 130 are used by the game server 116 to serve the online game 122 with game elements that are driven by the event center game system 150 and its corresponding event center 146, as will be discussed in detail with reference to FIGS. 2-7. Additionally, prize data 134, advertising data 136, and event center data 138 is stored in memory 120 after it is received from the event center game system 150. All or portions of this data is served to the client devices 184, 186 and may be displayed on the client devices before running a downloaded online game 122 or in some cases, during and as part of the online game 122 (e.g., in banners or other features of the online game display).

The system 100 includes client devices 184 used by players within the event center 146, such as network devices located in kiosks, in club suites, adjacent or proximate to stadium seats, or the like. These client devices 184 may be configured similarly to player client device 186 linked to the game provider system 110 via link 187 and network 140. The player client devices 186 as discussed above may take a variety of forms such as wired or wireless devices able to access network 140, to run an online game 122, and to display game graphics, e.g., a personal computer, a notebook, laptop, or handheld computer, a cellular or wireless phone, or the like. In this regard, the client device 186 is shown to include a processor or CPU 188, a display with user interface 189, and a network interface 190 for communicating with network 140. The display and user interface 189 may include a browser or similar application for displaying a web site and pages provided by the game provider system 110, with such web site and pages being used by the game provider system 110 in interfacing with the player, such as to facilitate player registration, player input of account/payment information, and player requests for a particular online game. The player client device 186 further includes memory 192 which may be used for storing some or all of a downloaded game 193, retrieved or received game data 194, advertising data 196, and event center data 198.

Generally, during operation, an operator or player uses the client device 184, 186 to access the game provider system 110, such as via a web site hosted by the game server 116. The player may register as a new user or log in as a previously registered player. The online game 122 in one embodiment is a pay-for-play game of skill and as such, the registration process will involve establishing an account for paying for plays of the online game 193 (e.g., using credit/debit account information to establish a bank that can then be debited as games are played such as at $5 to $10 increments with each game play costing $0.25, $0.50, or some higher or lower amount). The player may also be asked for identification information such as a name or player ID, contact information for use in notifying the player of a prize award and, optionally, for marketing of future online gaming events and activities at the event center 146. This player data 126 is stored at the game provider system 110 and later transferred to the event center game system 150 for storage in memory 160 at 166. The player requests access to play an online game 122, the game 193 is downloaded to the client device 184, 186 when payment account information is validated, and the player uses the client device 184, 186 to run and play the game 193. During play of the game 193, retrieved game data 194 such as a game leader board 132 and game elements based on parameters 130 are displayed in the display 189 and in some embodiments, the display 189 may also show all or portions of the advertising data 196 and event center data 198. After the game is played, the online game 198 transmits scores to the game server 116 for storage 128 and for use in updating the leader board 132.

According to one feature of the invention, the play of an online game 122 and award of prizes specified in prize data 134 is set by the event center game system 150 so as to be tied or linked to ongoing activities at the event center 146. For example, a contest or game event for an online game 122 may be associated with a set of events at the event center (such as one or more games played at the event center 146 by a sports team, e.g., a professional or college basketball, hockey, baseball, or football team). In this example, one or more prizes may be awarded based on the leader board 132 at the end of each event center event (or game) and another set of prizes awarded at the end of the set of events (such as 2 or more events or games). For example, smaller prizes may be given out at the end of each event in the event set being used to determine the playing period for the online game and larger prizes at the end of the event set. In this manner, the time period for playing each online game 122 is determined based on operation of and activities at the event center 146. Further, as will be discussed below, the prizes indicated by the prize data 134 are typically tied or linked to the event center 146, e.g., tickets for future events or activities at the event center 146 and/or paraphernalia associated with the activity or event (such as signed player jerseys and the like and in some cases, the prizes are awarded at the event center 146.

As illustrated, the event center game system 150 is provided within the event center 146 (although in other embodiments, portions of the system 150 may be located outside the center 146 with communicative links to other portions of the system 150 in the center 146). The event center game system 150 generally functions to provide a data collection and display interface with the event center 146 and with activities or games occurring at the event center 146. In this regard, the event center game system 150 is shown to include a processor or CPU 152 for managing operation of memory 160 and running software applications including the online game administrator 156. The system 150 also includes I/O devices 154 for interfacing with the network 140 over link 141 and interfacing with an operator of the system 150 and with data collection and display devices at the event center 146. An online game administrator 156 is provided for processing data collected at the event center 146 and providing other functions of the invention as discussed in more detail with reference to FIGS. 2-7 including establishing a prize pool 174, transmitting event data 180 to the game provider system 110, processing game information 164 including providing game element parameter values 169 to game provider system 110 for use in serving the online game 122, and generating and managing an advertising pool 170 with transmittal of advertising data 172 to game provider system 110 over network 140.

The event center game system 150 further includes one or more event center display mechanisms 158 that may be operated by the online game administrator 156 to display game information 164 and other information to market the online game 122 within the event center 146. Memory 160 is provided in the event center game system 150 for storing game schedules 162 defining the game(s) or activity(ies) at the event center 146 that are to be used in determining a playing time period for an online game 122. A database 164 of game information collected by the game provider system 110 is also stored in memory 160 and typically includes player data 166 that can be used to contact players to award prizes 176, 178 and to market the event center 146 and its activities to the player. The game information database 164 may also include leader information 168 (such as leader board or set of leaders for an online game 122) that can be displayed on the event center display mechanism 158 by the online game administrator 156 (or by the administrator 156 communicating with other control devices for the mechanism 158). The game information 164 may further include game element parameter values 169 that can be set by the online game administrator 156 (such as via operator input or based on collected event or event center data 180 such that game elements such as game environmental features or characters take on attributes related to the event center 146 and/or to events currently taking place at the event center 146).

The memory 160 further is used to store an advertising pool 170 containing advertising data 172. Typically, the advertising data 172 is information or ads provided by advertisers who are advertising within the event center 146 and have requested to sponsor the online game 122. In some embodiments, the advertising data 172 is identical or similar (or a portion of) advertising data displayed within the event center 146. In this regard, the game provider system 110 may use the game server 116 to serve advertising data 136 with an online game 122 such that the advertising data 196 displayed on the client device 184, 186 is linked or tied to concurrent advertising at the event center 146. For example, the advertising data 172 may include advertising content provided by an advertiser for one or more games or events at the event center 146, and this advertising data 172 may be provided as is or in a modified form as data 196 to be displayed as part of the online game 193 at the client device 184, 186 for a fixed time period before, during, and/or after the one or more games or events (e.g., during a basketball or other sports game and for a period before and after the game).

A prize pool 174 is generated by the online game administrator 156 and stored in memory 160 and includes, as shown, definitions for event center-linked prizes 176 and for advertiser-linked prizes 178. For example, the online game administrator 156 (e.g., with operator input) may be used to establish a list of prizes to give away for players on a leader board 132 at the end of each of a series of games/activities at the event center 146 and at the end of the entire series of games/activities. The event center-linked prizes 176 may be nearly anything linked either to the event center 146 or to teams/performers participating in events at the center 146. For example, the prizes 176 may include signed jerseys, balls, poster, or the like from the players or team in a sporting event application, may be specific seats for one or more upcoming event, may include access to performers at the event center 146, and other similar prizes. The prize pool 174 also includes advertiser-linked prizes 178 which may define one or more prizes linked to the advertisers who provided the advertising data 172, such as advertiser products or services.

The memory 160 is also used to store data 180 that is collected during an event held at the event center 146. This event data 180 is transmitted to the game provider system 110 for storage at 138 and at least periodic transfer to the client device 184, 186 for display before, during, and/or after playing of the online game 193. For example, the event center game system 150 may communicate with the computer system (not shown) used to track game information, such as score, time remaining, and the like in a basketball or other sports event. This information can be periodically transmitted to the game provider system 110 during the event at the event center 146 for display at the client device 184, 186, e.g., a player of an online game 193 may be informed of the current (or near current depending on the period used to transfer data 180, 138 and to display data on client device 184, 186) status of the game being played at the event center 146 while they are playing the online game 193.

With the general components of the system 100 described and understood, it may now be useful to explain with examples how the system 100 acts to integrate the various forms of data from the event center 146 and event center game system 150 into an online game at a client device 184, 186. FIG. 2 illustrates a screen shot 200 that may be displayed on the display 189 of a client device 186 during the running or playing of an online game 193. As shown, the online game 193 involves a basketball game of skill in which a player operating the device 186 attempts to make shoot basketballs into a basket in a particular time period. The game 193 is of a type that may be linked to an event center 146 in which a basketball team plays its games and as such, the game 193 would be linked with event center data 198 involving one or more basketball games at the event center 146 and with advertising data 196 associated with advertisers of those event center games.

As shown in the screen shot 200, the online game 193 generates a player-controlled character 210 that shoots basketballs while opposing characters 214, 218 attempt to block the shots. According to one aspect of the invention, each of the characters 210, 214, 218 may be configured based on game element parameters 130 provided from the event center game system 150 via game element parameter values 169. For example, the player-controlled character 210 may take the form and/or jersey of a player for the team for which the event center 146 is the home stadium or home court while the characters 214 and 218 may take characteristics of the visiting team's players and/or jerseys and the visiting or home team mascot, respectively. The game element parameters 130 are typically used by the game server 116 to configure the online game 193 prior to downloading but parameter values may be used to configure the game and character elements as the game 193 is run.

The game element parameters 130 and the associated characters 210, 214, 218 may be fixed for an online game for the game playing period or as is the case in one embodiment, are modified (or a different set is used) after the completion of each event or game being held at the event center 146. For example, the parameters 130 may be adjusted to match the next opponent or visiting team scheduled to play the home team of the event center 146 such that the online game's game elements are linked or tied to activity at the event center 146. The game element parameters 130 may also be used by the event center game system 150 to set environmental elements or features of the game 193 shown in the screen shot 200 including, for example, a center court emblem or design 220, signage 230, a scored board or display device 240, and its banners 248. These environmental elements may not be modified as often as the other features of the game 193 but are useful in linking the game 193 to the actual characteristics of the event center 146. Additionally, the display device 240 may be used to include the player's present score in a score display or box 244. Additionally, a leader board element 250 may be provided to display within the game screen 200 the current leaders of the online game 193 and their scores and IDs, with the content of the leader board element 250 being provided by the game server 116 as retrieved game data 194 (from leader board information 132 in memory 120).

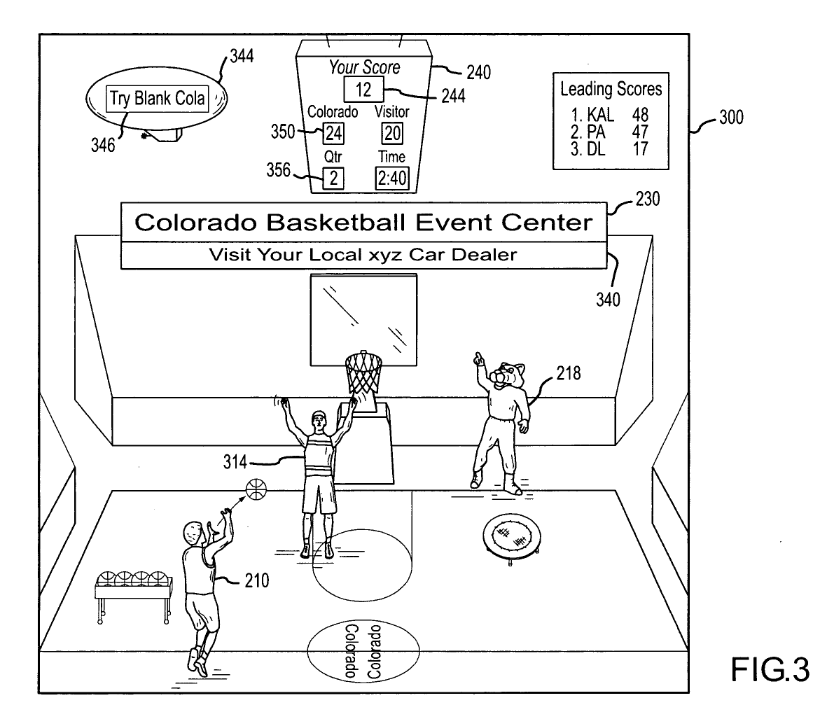

FIG. 3 illustrates a screen shot 300 of an online game 193 in which additional integration with the event center 146 and its data and activities occurs. As shown, a number of the game elements are similar to that of screen shot 200 including the player-controlled character 210, the mascot game character 218, the center court emblem 220, the signage 230, the score board 240, and the score display 244. However, the online game 193 is in this embodiment configured to use later retrieve game data 194 to present a new visiting player or opponent character 314 (such as with a different form and/or jersey matching a team scheduled for an upcoming game or that is presently being played). For example, if an online game 193 is played for a time period corresponding to a sports team hosted at the event center 146 playing five games, the game element parameters 130 may be modified five times to generate five different characters 314, with the change of characters 314 typically occurring after the completions of an event or game at the event center 146.

As shown in the screen shot 300, advertising data 196 provided by the event center game system 150 via game provider system 110 may also displayed as part of the online game graphics. As shown, an advertising banner 340 is provided as part of the display 300 of the online game 193, and the content of the banner 340 may be provided in the advertising data 196 (such as with a variable or parameter of the online game 193 run by client device 186. The content in some embodiments is the same or similar to that being run concurrently (or during an associated event or game) at the event center 146. Similarly, an advertising game element(s) 344 with a banner or display 346 may be provided in the online game 193 to provide additional advertising space and to also interact in the game play (e.g., to block shots in the illustrated example). Again, the content of the display 346 may match or be similar to that provided at the event center 146 as defined in the advertising data 176 in the event center game system 150. In this manner, advertising content can be linked to advertising content at the event center 146 and to advertisers sponsoring events at the event center 146. The advertising data 196 in the elements 340, 346 can also be controlled by the event center game system 150 and can be periodically updated and modified, such as for each event at the event center, for each series of events used to define the play period for the online game 122, and the like.

Further, the online game 193 may be adapted as shown to display event center data 198 provided via the game provider system 110 by the event center game system 150 based on communications with systems at the event center 146. As shown in screen shot 300, event center data 198 may include score information for a past, completed game at the event center or of an ongoing game, and this data may be displayed in the game scoreboard 240 as in event center score display element 350. The status of the game being reported may also be provided as part of the event center data 198, such as by reporting a game period (or inning or the like) and if appropriate, a time at which the score in element 350 was collected in a game status display element 356. Of course, these are merely illustrative examples, and the specific content of the event center data 198 displayed in a screen shot 200, 300 of an online game 193 may be varied widely to practice the invention. Likewise, the frequency at which the event center data 198 is updated may vary widely and may range to streaming or continuous to every minute or set of minutes to hourly or several hours to daily or longer.

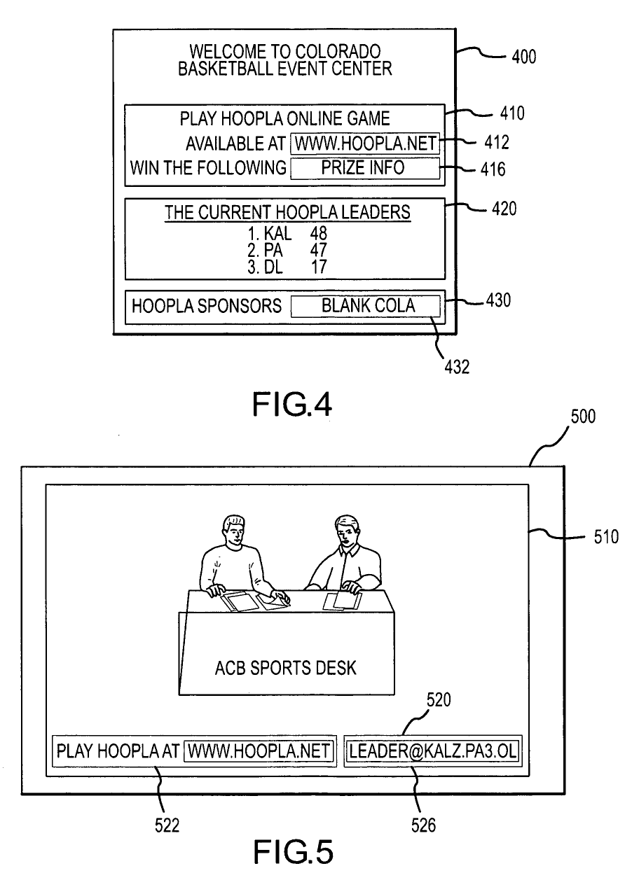

As noted above, the system 100 is adapted to facilitate marketing the online game 122 at the event center 146. In this regard, FIG. 4 illustrates a display mechanism 400 (such as mechanism 158 of FIG. 1) that is displaying event center information but also includes a display area 410 for displaying an advertisement for the online game. The advertising content in the display area 410 may include boxes or areas 412, 416 for displaying game information 164 including game access information, e.g., a URL of a web site hosted by game provider system 110 and for displaying prize information from pool 174. Additionally, the display mechanism 400 may be configured with a display area 420 for displaying a leader board or leader information 168 associated with the current (or past) online game 122. Yet further, the display mechanism 400 may include a display area 430 for displaying advertiser information for the online game 122 as well as a box, banner, or the like 432 for displaying advertising data 172, which may be the same as displayed in the event center 146 and/or as displayed in the game 193 as advertising data 196 on the client device 184, 186. Operation of the event center display mechanism 400 is controlled, at least in part or indirectly, by operation of the online game administrator 156 which may process the game information 164, advertising data 172, and prize pool data 174 and present all or a subset of such data for display on the mechanism 400 and in which locations.

FIG. 5 illustrates in simplified form a device, such as television, 500 with a screen shot 510. As shown in FIG. 1, the event center game system 150 may be communicatively linked with a media system or media computer system 182. The event center game system 150 operates the online game administrator 156 to periodically feed or transfer information regarding the online game 122 from memory 160. The information is stored as game information 183 at media system 182 and may be output by announcers or personnel of the broadcasting network presenting the output signal used to create display 510. Additionally, the media system 182 may operate to periodically retrieve the game information 183, format the information 183, and display the information 183 or portions of the information in a fixed or rolling banner or portion 520 of the display 510, such as a scrolling banner or ticker at the bottom or top of the screen as shown. The display 520 includes game information in box 522 (such as game access information) and in box 526 (such as leader information). The display 520 may also display advertising data 172 in some embodiments not shown.

FIG. 6 illustrates a method 600 for provisioning or providing an online game, such as game 122, according to the present invention. The method 600 starts at 602 typically with detailed planning of the theme of the online game 122 (e.g., a game involving skills related to those of the event center activity) and features or game elements to include in the online game 122 to facilitate integrating the online game 122 with a particular event center 146 and events, such as basketball, hockey, football, baseball games or other entertainment activities. For example, game elements such as structural features, signage, and advertising banners may be selected to match those at the event center 146 and/or to make it easier to display event center data and/or advertising data. Game elements such as characters may be selected to match those taking part in the games or activities at the event center for the play period for the online game 122 and may be modifiable to better match each game/event in a series of such games/events associated with the online game 122.

At 610, the method 600 continues with creating technical aspects of the online game 122 including the modifiable environment and character elements. At 620, based on the event center 146, the method 600 continues with establishing game element parameter values and then, modifying online game 122 as necessary. Step 620 may involve the online game administrator 156 operating to create a set of game element parameter values 169 that define at least partially one or more of the game elements defined in 610, and these definitions or values are selected to match the physical characteristics of the event center 146 and also the operation of the event center 146 (such as which teams play there, the mascots, other “characters” such as dancers, cheerleaders, vendors, and the like, and variable elements such as advertising blimps and the like).

At 630, the method 600 continues with creating an advertising pool 170 for the online game 122. This generally involves establishing a set of sponsors for the game 122 such as a subset of the advertisers of corresponding events at the event center 146, and then, operating the online game administrator 156 to set up a database of advertising data 172 for integration with the online game 122 and with marketing of the game 122 at the web site of the game provider system 110, the event center 146 by the event center game system 150, and/or the media system 182. At 640, the method 600 continues with establishment of a prize pool 174. Significantly, the prize pool 174 is created by the online game administrator 156 to include event center-linked prizes 176, i.e., prizes that are related to the event center 146, such as tickets to upcoming events including seats behind the home team bench or the like, passes to event center events not open to the public, and other prizes that can only be offered by the operator of the event center 146 or in conjunction with such an operator. Further, the prize pool 174 may be created to include one or more advertiser-linked prizes such as products or services offered by advertisers associated with the event center 146 and/or the advertising data 172 (i.e., advertisers sponsoring the online game 122). The prize pool 174 may also be divided into sets of prizes for award at the completion of each game or event in a series of games or events held at the event center and a set of prizes for award at the completion of the final game or event in the series of games or events that is used to set the time for playing the online game 122.

At 650, a schedule for the online game 122 associated with the prize pool 174 is generated and stored in memory 160 at 162. The online game 122 may be associated with a single event or game at the event center 146, and in this case, the online game 122 may be played only concurrently with the live game or event but more typically is scheduled for play for a period before the game and during the game with the termination of the play period being at the end of the game or event (or before the end such that the winner(s) can be announced at the live game within the event center 146 such as on the display mechanism 158). At 660, the method 600 continues with the event center game system 150 providing the schedule 162, the parameter values 169, and/or advertising data 172 to the game provider system 110 for use by the game server 116. At 670, the game server 116 offers access to the online game 122 over the network 140. This offering 670 may include hosting a web site which is accessible by client devices 184, 186 and that allows client devices 184, 186 to download the game 122, as is explained in more detail below with reference to FIG. 7.

FIG. 7 illustrates a method 700 of administering or managing an online game according to the present invention and as may be provided by operating system 100 of FIG. 1. The method 700 starts at 702 such as with the finalization of method 600 and operation of the game provider system 110 to store the data shown in memory 120 and establishing an accounting system (not shown) for facilitating registration of players or users, tracking the value of the account, and the like as is well known in the industry for online games of skill (e.g., pay-per-play accounting over a network).

The method 700 continues at 710 with the game provide system 110 acting to provide access to the online game 122 over the network 140. At 718, the game server 116 (or online game administrator 156 may notify the game server 116 at the end of the period) determines whether the time period for playing the online game 122 is over. For example, the time period may be a set period of time before one or a set of games or events at the event center 146 up to the end or during the one game or the last game in a series of games (such as one week or several days before a first game and then ending at the end or during a last game in the set or series of games). If the period is over, the method 700 continues at 770 with reporting the prize winners based on the leader board or set of leading scorers at the time the period ended. Note, as discussed above, the game period may include check points or sub-terminal points at which prizes are also awarded and these subsets of the overall time period are also tracked during the method 700, such as by operation of the game server 116 and/or the online game administrator 156. At 770, the leaders may also be directly notified of the status of the leader board 168 and their eligibility for a particular prize, along with directions on how to receive the award. In one embodiment, step 780 is included in the method 700 and involves the prizes being awarded to the winning players at the event center 146. For example, the winners may be notified by email, mail, telephone, and/or other methods, and at an established next event, be presented their award, e.g., at half court of a basketball court, on the ice in hockey arenas, or on the field for football, soccer, and baseball. In this additional manner, the playing and administering of the online game 122 is tightly linked with the operation of the event center 146 and activities occurring at the event center 146 in a manner not achieved in prior online gaming methods. At 790, the method 700 is ended.

If the period, e.g., the overall game playing period, is not over, the method 700 continues along three concurrent pathways. At 720, the online game 122 is marketed to attract additional players to play the game 122. For example, the game 122 is pushed and published on the game provider system's web site and also on one or more web sites associated with the event center 146 and often, with the organization or team performing at the event center 146 to which the game 122 is typically tied or linked. The online game 122 is usually also marketed at the event center 146 with publications provided to people attending events, with audio announcements, and with visual displays, e.g., display mechanism 158. The game 122 may also be marketed via the media system 182 before and during play of the game 122. Preferably, the marketing of the game 122 continues through the game playing period as shown in FIG. 7.

The method 700 also proceeds down the path began with step 730 including registering or logging in users for the online game 122. Step 730 typically includes the player indicating whether they are a new player who has to establish an account to pay for playing the game or an existing player who previously set up an account. For new players, a set of data is collected including payment information, a player ID which may be their name or a unique identifier, contact information, and optionally, demographic information useful for later marketing to the player for activities at the event center 146. Once the player is registered or logged in to the game provider system 110, the method 700 continues at 736 with the player stating the amount they wish to spend or how many games they wish to play at this time and the player then uses their client device 184, 186 to play the online game 193 which has been downloaded to the device 184, 186 along with any relevant game data 194, advertising data 196, and event center data 198. As discussed with reference to FIGS. 2 and 3, advertising data and/or event center data 196, 198 may be displayed within the display or graphical output or window of the online game (e.g., on the display 189 of the client device 184, 186 within or without the game frame or window).

At 740, the method 700 continues with gathering the player score(s) by the game server 116 (e.g., the online game 193 may be adapted to transmit the score at the end of the game(s), the game server 116 may remain in communication over the network 140 to provide game data and to collect game data, or some other useful configuration may be used) which is stored 128 in memory 120. The game server 116 then acts to update the leader board 132 which is transmitted at 742 to the client device 186 if the user is still connected or at the next registration or playing session and transmitted to the event center game system 150 for storage at 168 in the memory 160 and for publication by the online game administrator 156, such as with the event center display mechanism 158 and/or the media system 182. At 750, the game server 116 acts to update user or player account information such as may be stored as player data 126 to reflect the charge for playing the game 122 on the client device 184, 186. The method 700 then determines whether the play period is over or if additional players can register/log in to play the game 122.

At 760, the method 700 is shown to include the gathering of event center data 180 by the online game administrator directly or more typically, through communication with other computer systems (not shown) operating at the event center. The collected event data 180 may include live event data such as when an event or game is occurring at the event center 146. At 766, the event center data 180 is transmitted by the online game administrator 156 to the game provider system 110 for serving with the online game 122 to client devices 184, 186, e.g., to the next registering users or to those already registered and online with an update of the event center data 198.

From the discussion of FIG. 1-7, it can be seen that the inventive method and system provides a number of advantages over prior online gaming systems. The online game is linked to an event center and more particularly, to events or activities occurring at such an event center. This allows the online game to generate with game elements, advertising data, and event center data that originates from an event center game system that is in communication with event center computer or data systems. As a result, the online game may include elements and data that are linked to planned or even concurrent activities at the event center. In some embodiments, the online game is adapted to take on the environmental look and feel of the event center and to include characters or other game features from the activities at the center (such as team members, mascots, advertising devices, and the like). Further, a prize pool is linked to the event center and its activities, which enables the method and system of the invention to entice players with an opportunity to win prizes not available or readily available from any sources. The techniques of interfacing the online game play and game serving with the operation of the event center also enable the method to include displaying game data and information, such as game access information and leader board information at the event center. The leader board is preferably updated nearly continuously (such as after each player plays a game) such that the leader board displayed or reported via the event center display mechanisms or media systems is substantially current. The database of player information is maintained to allow the game server or event center game system to market or promote upcoming online games and other event center activities via email or other communication channels.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A computer-based method of serving an online game that is linked to an event center and data structures at the event center, comprising:
providing on a server an online game comprising a plurality of game elements, wherein at least one of the game elements is configured based on a characteristic of the event center;
determining a schedule for playing the online game, the playing schedule being a time period including occurrence of at least one event at the event center;
serving the online game to a plurality of client devices over a communications network for a length of time equal to the playing schedule;
during the serving, gathering scores for the online game for operators of the client devices; and
determining a set of high scores for the online game from the gathered scores.

2. The method of claim 1, further comprising awarding a set of prizes to the operators of the client devices associated with the set of high scores, wherein the set of prizes comprises event center-linked prizes and wherein an end of the time period for the playing schedule coincides with an ending time for the at least one event.

3. The method of claim 2, wherein the event center-linked prizes include prizes related to performers in the at least one event occurring at the event center.

4. The method of claim 2, wherein the time period for the playing schedule is established based on the occurrence of two or more events at the event center and further wherein the schedule determining comprises determining subsets of the playing schedule based on each of the events occurring at the event center, and further wherein the determining of the set of high scores and the awarding of the prizes are performed at the end of each of the subsets of the playing schedule.

5. The method of claim 1, wherein the characteristic of the event center used for configuring the at least one game element is defined with a game element parameter defining a structural feature of the event center or a character or a movable object associated with the at least one event occurring at the event center.

6. The method of claim 5, wherein the at least one event occurring at the event center is a sporting event involving a team member and the game element parameter defines the character based on the team member.

7. The method of claim 1, wherein at least one of the game elements comprises an advertising banner for presenting advertising data, the advertising data presented in the advertising banner comprising advertising data associated with the event center.

8. The method of claim 1, wherein at least one of the game elements comprises a display area and wherein the display comprises data collected from the event center during the occurrence of the at least one event.

9. A computer-based method for serving a video game over a communications network, comprising:
storing executable code for the game in a data structure on a server system linked to the network;
storing a set of prize definitions in a data structure on the server system, the prize definitions defining a plurality of prizes linked to an event center including prizes associated with events occurring at the event center;
providing the game code to client devices linked to the network;
receiving scores from the client devices based on running the game code on the client devices;
determining from the received scored a set of high scores;
matching the set of high scores to the set of prizes defined by the prize definitions; and
reporting winners of the game based on the matching.

10. The method of claim 9, wherein the game code providing is performed for a time period in which a set of the event center events occur, the time period having an ending time coinciding with an end time for a last one of the set of event center events.

11. The method of claim 9, further comprising prior to the matching and the reporting, displaying the set of high scores on a display mechanism at the event center during one of the events.

12. The method of claim 9, further comprising receiving at the game server system a set of game element parameter values for use in defining parameters in the game code in generating game elements representative of features of the event center when the game code is run on the client devices.

13. The method of claim 12, wherein the event center features are performers in one or more of the events occurring at the event center.

14. The method of claim 9, further comprising receiving at the game server system advertising data comprising event center advertising content, wherein the received advertising data is provided with the game code to the client devices and wherein the advertising data is displayed on the client devices as a part of a game output display when the game code is run on the client devices.

15. The method of claim 14, further comprising receiving at the game server system data collected during one of the events at the event center, wherein the received event data is provided with the game code to the client devices and wherein the received event data is displayed at least in part on the client devices when the game code is run on the client devices.

16. The method of claim 9, wherein the reporting of the winners of the game comprises transmitting an electronic message over the network to the winners and displaying a list of the winners on a display mechanism at the event center.

17. An online gaming method for managing play of a video game by a plurality of client devices operated by users or players and linked to a communications network, comprising:
storing a schedule defining a beginning time and an ending time for playing the game, wherein the beginning time and ending time are selected such that an event is scheduled to be held at an event center within the game schedule;
providing the game on a server linked to the communications network;
receiving advertising data from an event center computing system; and
responding to requests from the client devices for the game by operating the server to serve the game to the requesting client devices along with at least a portion of the advertising data, wherein the game operates to display the at least a portion of the advertising data when the game is run on the client devices.

18. The method of claim 17, wherein the game is configured with executable code to display game elements when the game is run on the client devices, and wherein the method further comprises defining a set of game element parameters based on the event scheduled to be held at the event center, the defined game element parameters being used by the game to display the game elements.

19. The method of claim 17, further comprising storing a prize pool for the game comprising a list of prizes linked to the event center or to the event scheduled to be held at the event center and awarding the prizes in the prize pool to a set of the players operating the requesting client devices based on scores generated during running of the game on the client devices.

20. The method of claim 19, further comprising prior to the responding to the requests, operating the event center computing system to gather data related to the event as it is being held at the event center and to transmit the event data to server for transmittal with the served game and after the awarding of the prizes, operating the event center computing system to operate a display mechanism positioned at the event center to display the set of the players awarded the prizes
